(19) United States
(12) Patent Application Publication
(10) Pub. No.: US 2014/0248114 A1
(43) Pub. Date: Sep. 4, 2014

(54) LIFTING DEVICE FOR CONVEYOR EQUIPPED VEHICLE AND METHOD THEREOF

(71) Applicant: HENRY SAWYER, Orlando, FL (US)

(72) Inventor: HENRY SAWYER, Orlando, FL (US)

(21) Appl. No.: 13/783,467

(22) Filed: Mar. 4, 2013

(51) Int. Cl. B60P 1/02; B66F 7/06

(52) U.S. Cl. CPC B60P 1/02; B66F 7/065
USPC 414/812; 254/113; 254/93 VA

(57) ABSTRACT

A lifting device for conveyor equipped vehicles includes a lift frame and an upper platform deck, each having an overall shape and construction suitable for receiving a commercial pallet, a pair of opposing scissor lifts interposed between the lift frame and the upper platform deck, and a lifting device.

### TECHNICAL FIELD

The present invention relates generally to lifting equipment, and more particularly to a lifting device for a conveyor equipped vehicle.

### BACKGROUND

The statements in this section merely provide background information related to the present disclosure and may not constitute prior art.

As shown in FIG. 1, roofing companies often utilize delivery trucks 1 having a flat truck bed 2 secured to the truck frame 8, that are equipped with a lift conveyor system 3 for supplying shingles and other such roofing articles 4 to a home or building 5. These vehicles are typically outfitted with a hydraulic system having a plurality of individually operable hydraulic ports that are controlled by a hydraulic system controller 6.

As such, when the truck arrives at the destination, the conveyor is extended until the upper portion 3a is in communication with the roof, and the lower portion 3b is positioned adjacent to the roofing materials. Workers 7 then act to physically lift each of the roofing materials 4 from pallets 4a or other such shipping containers and place the same onto the conveyor system which transports the roofing materials onto the roof of the building.

This procedure works well and allows the roofing materials to be quickly transported onto the roof in a relatively safe and standardized manner. However, the above described procedure has one significant drawback. In order to operate in the most efficient manner, the lower portion of the conveyor system is designed to receive the roofing materials at approximately two or three feet above ground level, which corresponds with the waist height of the average worker.

Roofing materials 4 such as bundles of shingles, for example, are extremely heavy and can weigh between 75 and 100 pounds each, and a typical pallet contains upwards of 40 individual bundles. As these materials arrive in fixed stacks positioned on the bed of the delivery vehicle, the height of the stack decreases exponentially as more and more of the materials are removed. As a result, approximately 30-50% of the shingles removed from the stack and loaded onto the conveyor must be lifted from a height that is beneath the conveyor itself. This is particularly troublesome when the stack is reduced to the last several rows wherein the worker must bend to the floor to retrieve the heavy materials and then load the same onto the conveyor.

As a result of the extreme weights and amount of bending involved, back injuries among roofers are a common occurrence. Depending on the severity of the injury, workers careers can be cut short and employers loose valuable team members in whom years of training have already been invested.

Accordingly, it would be beneficial to provide a durable lifting device capable of constantly maintaining a stack of roofing materials at a level height with a corresponding conveyor system.

### SUMMARY OF THE INVENTION

The present invention is directed to a lifting device for conveyor equipped vehicle. One embodiment of the present invention can include a lift frame having a plurality of elongated members forming a generally rectangular shape. A platform deck having a dimension suitable for receiving a shipping pallet is secured to the lift frame via a pair of scissor lifts. A lifting device which can include a hydraulic cylinder, can be secured to the vehicle hydraulic system in order to operate the device.

Another embodiment of the present invention can include one or more ramps hingedly secured onto the platform deck 30 to aid in receiving palletized or loose materials.

Yet another embodiment of the present invention can include an alternate cylinder system capable of applying at least one of a pneumatic, self-sustained hydraulic or purely mechanical force to the scissor lifts.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a side view of a conveyor equipped truck in accordance with background information that is useful for understanding the inventive concepts disclosed herein.

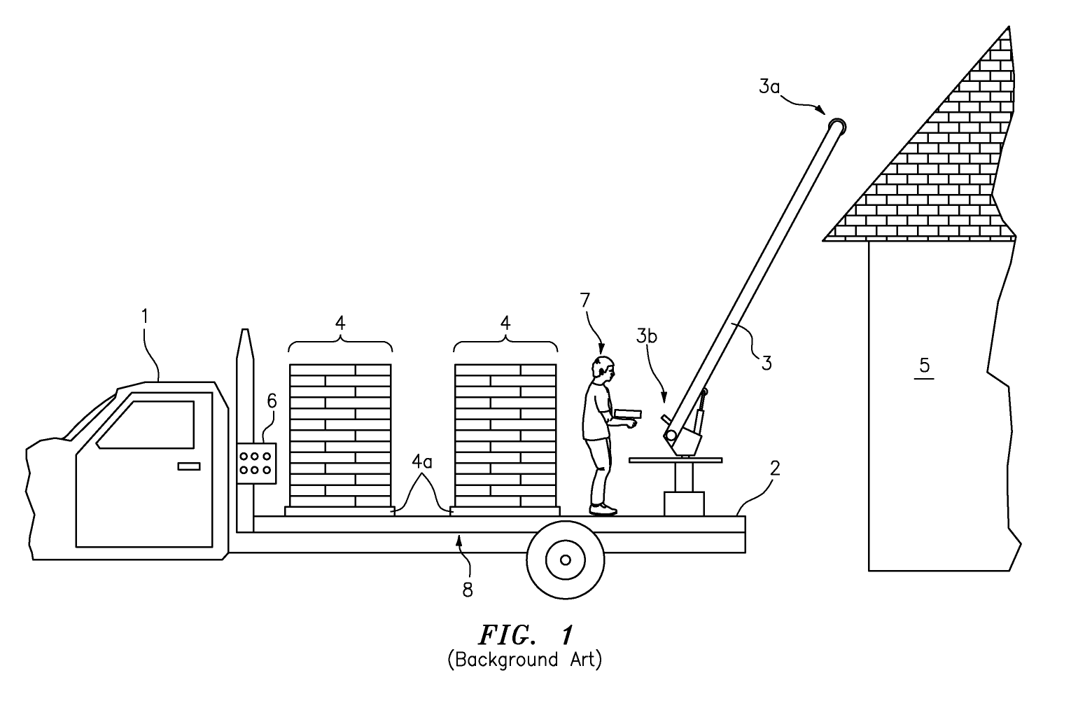

FIG. 2 is a perspective view of the lifting device in accordance with one embodiment of the invention.

FIG. 3 is another perspective view of the lifting device in accordance with one embodiment of the invention.

FIG. 4 is a top view of the frame of the lifting device in accordance with one embodiment of the invention.

FIG. 5 is a cutaway inside view of the lift frame member taken from

FIG. 6 is a side perspective view of the lifting device in accordance with another embodiment of the invention.

FIG. 7 is a perspective view of the lifting device in a closed configuration, in accordance with one embodiment of the invention.

FIG. 8 is a side view of the lifting device in operation, and in accordance with one embodiment of the invention.

FIGS. 9a and 9b are top views of the device in accordance with alternate embodiments of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

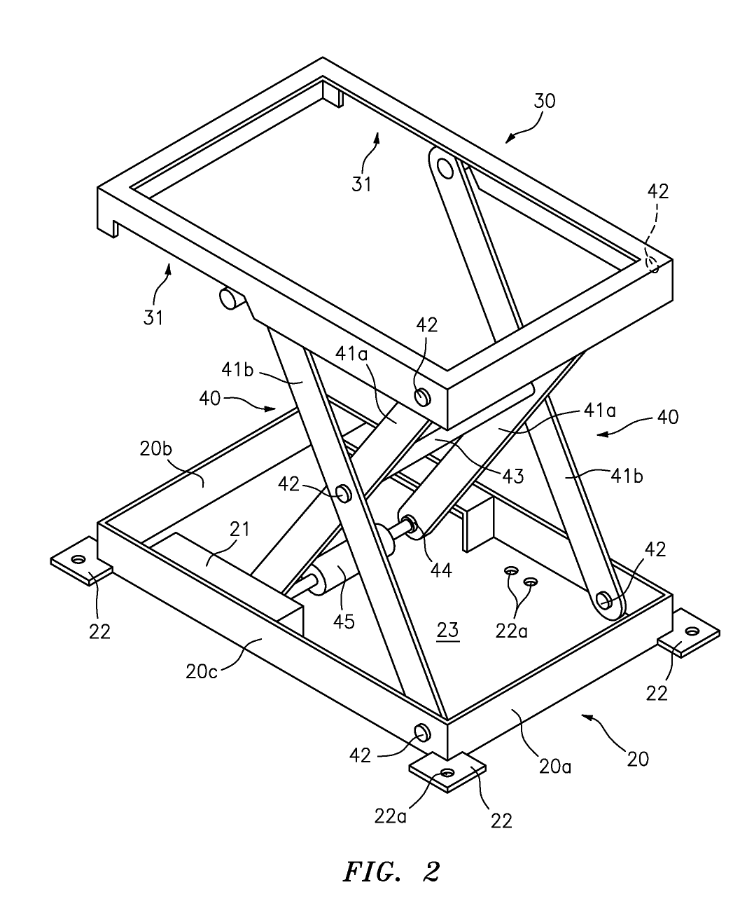

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

Although illustrated herein as being utilized with a conveyor equipped vehicle, this is for illustrative purposes only, as the inventive concepts disclosed herein can be applied to virtually any application.

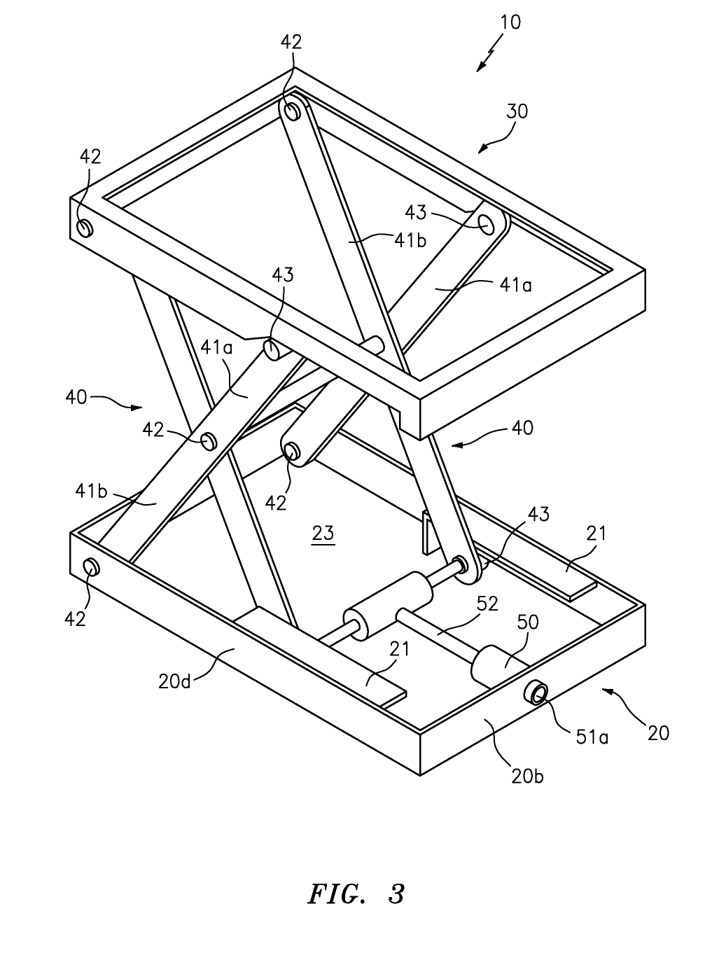

FIGS. 2 and 3 illustrate one embodiment of a lifting device for conveyor equipped vehicles that is useful for understanding the inventive concepts disclosed herein. As shown, the device 10 can include a pair of hydraulically powered scissor lifts 40 interposed between a lift frame 20 and an upper platform deck 30.

The lift frame 20 can act as the base for supporting each of the below described elements. In one embodiment, the lift frame can be constructed from four elongated steel or iron members 20a, 20b, 20c, and 20d that are welded at each corner to form a generally rectangular shape suitable for receiving the scissor lifts 40 and platform deck 30 described below. A pair of glide channels 21 can be formed along the inside facing portion of members 20c and 20d to accommodate movement of the lower scissor rollers 43 that will also be described below. Additionally, an opening 24 can be positioned within member 20b through which a hydraulic connector 51 can be positioned.

A generally flat frame plate 23 can be secured to each of the lift frame members along their respective bottom surfaces to create a smooth base for resting on the truck bed. The lift frame can also include a plurality of attachment plates 22 designed to anchor the frame to the bed of a vehicle. These plates can be located anywhere along the frame members and can further include openings 22a for allowing the frame to be bolted to the truck bed. Alternatively, openings 22a can be disposed along the frame plate 23 itself to allow the same to be directly secured to the truck bed with or without the attachment plates.

The platform deck 30 acts to physically receive palletized roofing materials. As such, the platform deck 30 can also be constructed from four elongated steel members welded at each corner to form a generally rectangular shape having an overall dimension that is complementary to a standardized pallet. A pair of glide channels 31 can be positioned along two of the platform deck members at locations above the glide channels 21 described above. Glide channels 31 acting to accommodate movement of the upper scissor rollers 43 attached to the scissor lifts 40. As described herein, glide channels 21 and 31 can include elongated channels having a dimension suitable for receiving rollers 43 to allow for linear movement of the same within the channels.

In one optional embodiment, the top surface of the platform deck can further include a steel plate 31 that connects each of the elongated members. Such a feature can advantageously allow the platform 30 to support heavy materials such as bundles of shingles, for example that are not pre-loaded onto pallets or other such shipping/transportation containers.

Although described above as utilizing welded steel plates, this is for illustrative purposes only, as any number of other known materials and construction methodologies can also be incorporated herein.

In one embodiment, a pair of steel scissor lifts 40 are positioned between the lift frame 20 and the platform deck 30. As shown, each of the lifts can be positioned on opposite sides of the device and can act to transform the linear mechanical force applied by the hydraulic cylinder into vertical movement of the upper platform deck. Each of the lifts 40 include a pair of cross members 41a and 41b, respectively, that are joined in their center by a scissor pin 42. A generally orthogonal cross brace 43 connects the lifts 40 together along their central axes.

The upper end of each opposing cross member 41a, and the lower end of each opposing cross member 41b are joined to the platform deck 30 and the lift frame 20, respectively, via scissor pins 42 or other known hardware capable of securely positioning an attached cross member at a fixed location, while permitting the cross member to rotate about a central axis. The upper end of each opposing cross member 41b can include rollers 43 disposed along their outside facing surfaces. Rollers 43 being secured to the cross members in order to allow the same to slide in a linear fashion within the glide channels 31 of the platform deck.

An elongated lift bar 45 acts to receive the mechanical force of the hydraulic cylinder and to apply the same to the cross members 41b. As such, the lift bar 45 is positioned orthogonally to each of the cross members and acts to pass through openings 44 on the bottom ends of cross members 41b. A pair of rollers 43 are secured to the ends of the lift bar 45 in order to allow the same to slide linearly within the glide channels 21 of the lift frame. A central reinforced section 45a is disposed along the central portion of the lift bar for mating with the piston rod 52 and receiving a mechanical force.

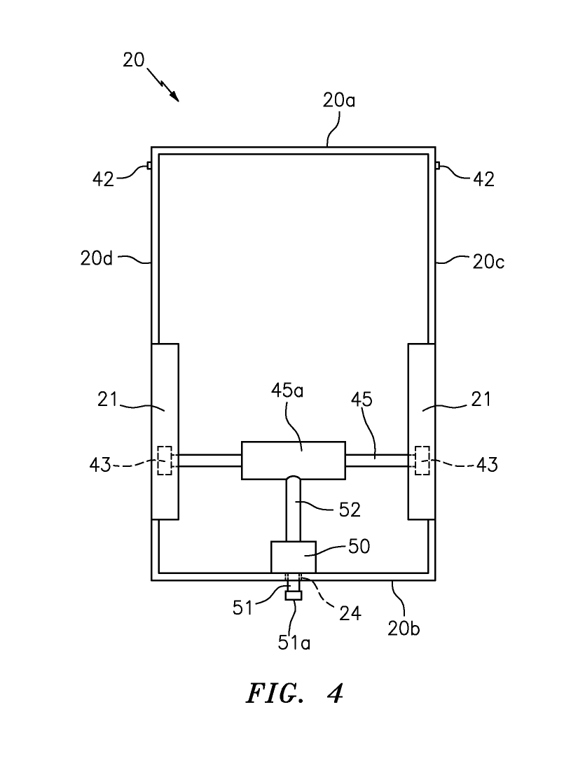

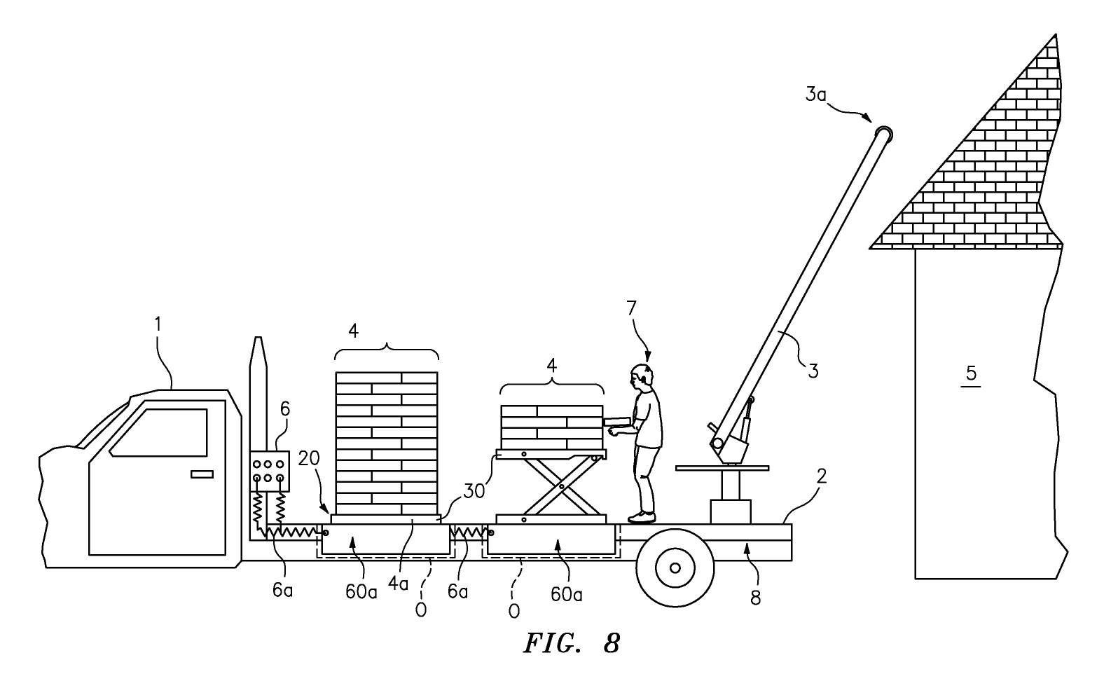

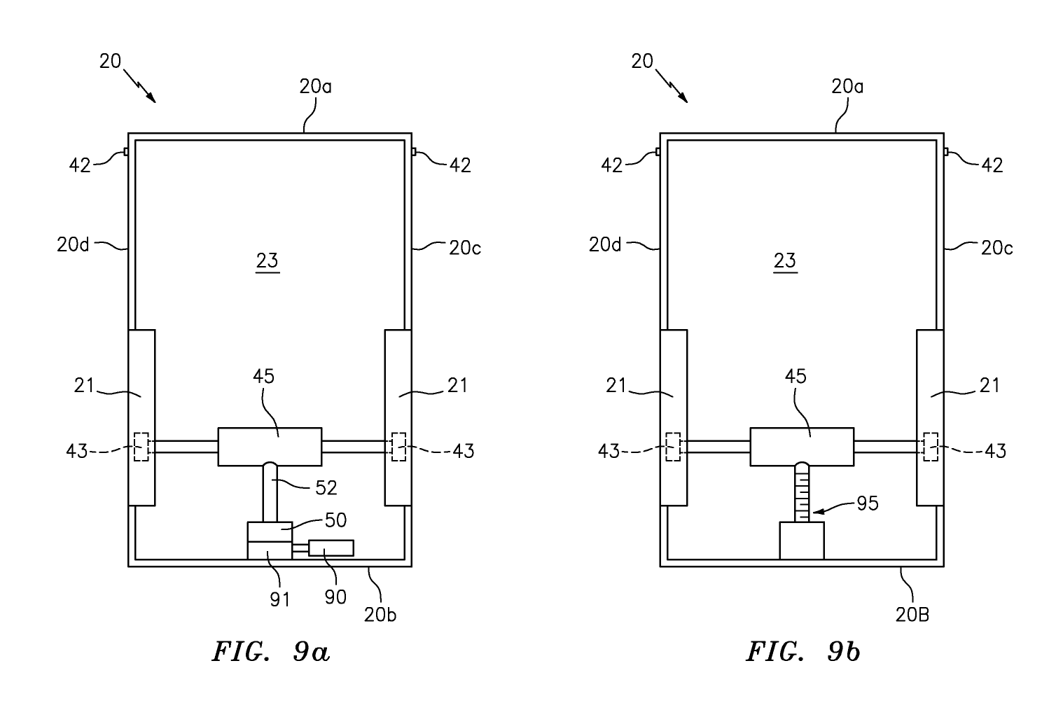

As shown in FIG. 4, a lifting device 50 having an adjustable length arm 52 is disposed between the lift frame 20 and the lift bar 45. In one preferred embodiment, the lifting device 50 can comprise a hydraulic cylinder that is secured to the lift frame 20b at a location adjacent to the lift bar 45. A hydraulic line connector 51 having a vehicular hydraulic line adaptor 51a is provided to connect the cylinder to the hydraulic system 6 of the vehicle 1 via a vehicular hydraulic line (See FIG. 8). The adjustable length arm 52 can comprise a piston rod of the hydraulic cylinder that is secured to the protrusion 45a of the lift bar 45 to maintain constant contact therewith. Although described above as utilizing a hydraulic cylinder, this is for illustrative purposes only, as any number of other lifting devices suitable for creating a driving force sufficient to raise and lower the platform deck can also be utilized. Several non-limiting examples are also described below with respect to FIGS. 9a and 9b.

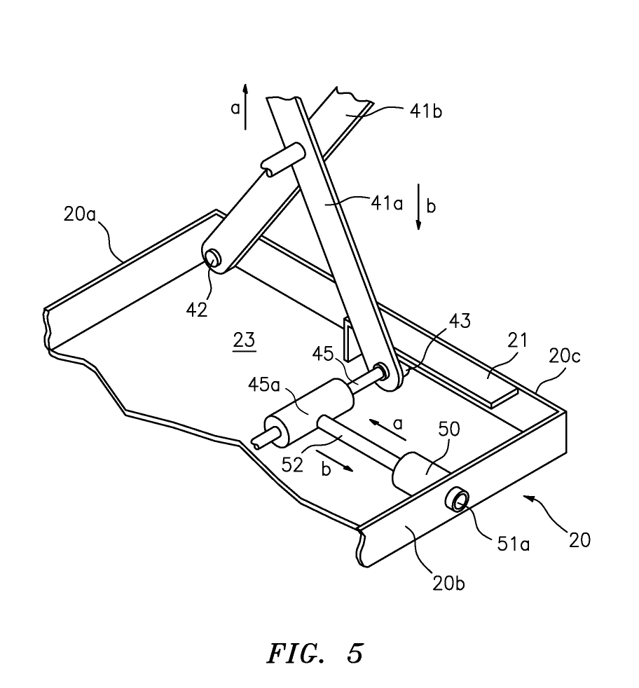

FIG. 5 illustrates a cutaway inside view of the lift frame member 20d taken from FIG. 4. As shown, scissor cross member 41a is secured to the roller 43 and the lift bar 45 and acts to move along the glide channel 21 of the lift frame. Scissor cross member 41b is secured to the opposite end of the frame member 20d via another scissor pin 42. As such, when hydraulic fluid is supplied to the hydraulic cylinder via the vehicle hydraulic system 6, the cylinder 50 pushes the piston 52 that is attached to the lift bar 45 towards the frame wall 20a. This action pushes the bottom end of lift arm 41a towards the bottom end of lift arm 41b (see arrow a), thereby causing the other ends of lift arms 41a and 41b connected to the platform deck to rise. Conversely, when the hydraulic system 6 removes the pressurized fluid from the cylinder, the piston is withdrawn back towards wall 20b, and both the scissor arms and platform deck are lowered (see arrow b).

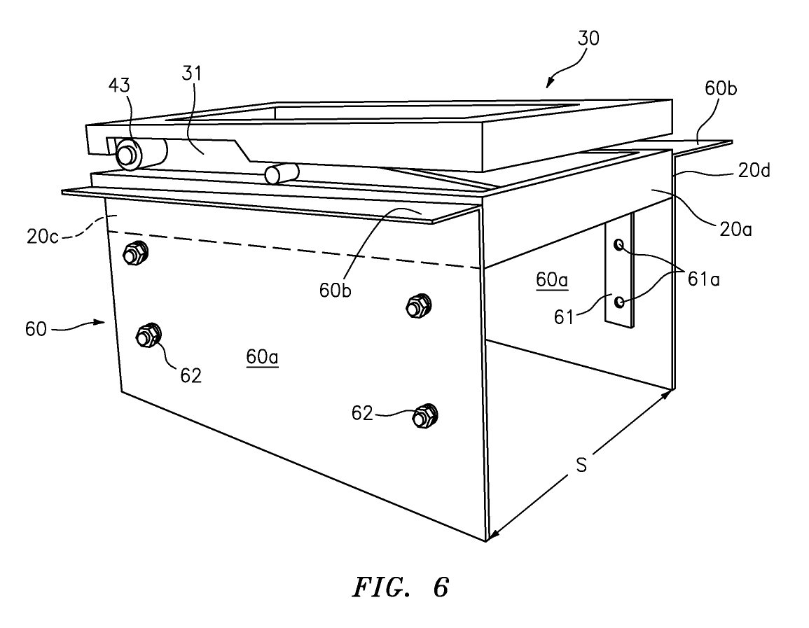

FIG. 6 illustrates one embodiment of the lifting device that further includes a pair of elongated generally L-shaped frame rails 60 which act to secure the device directly to a vehicle frame 8. As shown, each of the rails can include a vertical section 60a and a horizontal lip-section 60b extending from the frame members 20c and 20d, respectively. Rails 60 include a separation distance S creating a space for receiving the frame of the vehicle located beneath the truck bed. In one preferred embodiment, the space S can include a distance of approximately 24 inches which is a standard separation distance of many commercial truck frame elements.

However, as other frame element spacing's can be utilized by various truck manufacturers, one alternate embodiment can further include a plurality of mounting brackets 61. Each of the mounting brackets can include a thickness of between approximately ½ and two inches, and can be secured to the inside portion of the frame rails 60a to adjust the spacing distance S in order to accommodate smaller truck frames. Likewise, the mounting brackets 61 can also be secured to the outside facing portion of the frame rails 60a to adjust the spacing distance S in order to accommodate larger truck frames. In either instance, and as shown, each of the brackets 61 can further include a plurality of openings 61 a suitable for receiving bolts 62 or other such connection hardware necessary to anchor the device to the truck frame. Of course, any number of other components and connection methodologies such as welds, for example, can also be utilized to secure the device to the truck.

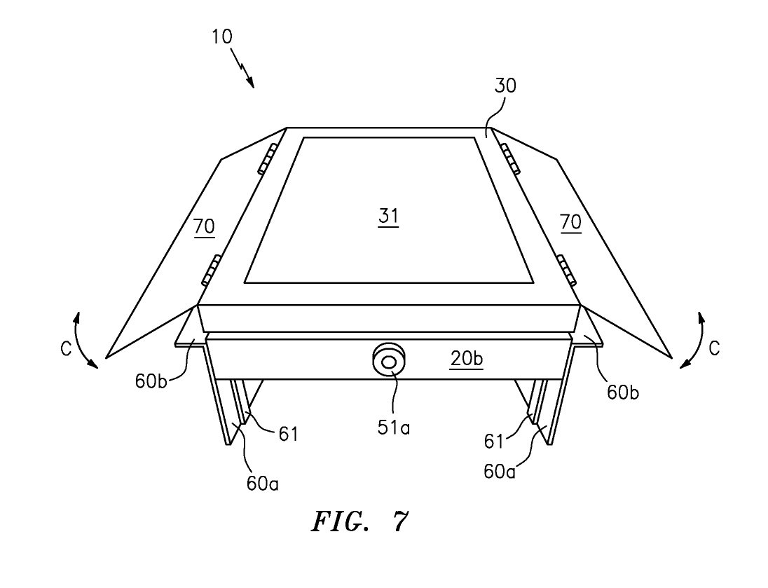

FIG. 7 illustrates the lifting device for conveyor equipped vehicle 10 in a retracted position wherein palletized materials can be loaded onto the platform deck 30. As shown, one or more optional ramps 70 can be hingedly secured to one or more sides of the platform deck 30 and can move up and down (see arrow c) to allow for easy loading and unloading of pallets and the like.

As shown in FIG. 8, one preferred method for utilizing one or more devices 10 on a vehicle can include providing an opening O sufficient to accommodating each device. These openings can be cut into the floor 2 of the truck at a location above the truck frame 8. Once the openings are established, the vertical portion of the frame rails 60a can be lowered into the opening O until the lip section 60b makes contact with the floor 2. At this time, any required mounting brackets 61 can be interposed between the vertical section of the frame rails 60a and the truck frame 8. Once positioned, the frame rails can be secured to the truck frame via bolts or other such mounting hardware.

In operation, a hydraulic cable 6a can be secured between the vehicular hydraulic system and the line adaptor 51a of the device. Operation of the device 10, i.e., raising and lowering the upper platform deck can be controlled utilizing the hydraulic control system 6 of the vehicle 1. Such a feature allows the inventive concepts disclosed herein to be utilized in a cost effective manner and without duplicating control surfaces. As such, the device 10 can be quickly and cost effectively incorporated into existing and new construction vehicles alike.

Although described above as utilizing a hydraulic cylinder that is connected to a vehicle hydraulic system, this is for illustrative purposes only. As will be known to those of skill in the art, other embodiments can substitute essentially identical pneumatic components to allow the device 10 to be operated from an external air compressor. Additionally, FIGS. 9a and 9b illustrate alternate embodiments of the lifting device 10 that further includes an electrically operated hydraulic motor 90 having a self-contained hydraulic fluid reservoir 91 for allowing the device to function as a self-contained hydraulic system. Alternatively, the hydraulic elements can be completely removed, and replaced with an electrically powered linear actuated motor 95. Such features can allow the inventive concepts described herein to be utilized by vehicles that are not already equipped with an onboard hydraulic system. Although not shown, each of the embodiments illustrated in FIGS. 9a and 9b can further include any number of controllers for operating the device.

As described herein, one or more elements of the lifting device for conveyor equipped vehicle 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the frame members 20a-20d, and the elongated platform deck members, for example, may be formed together as continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A lifting device for conveyor equipped vehicles, said lifting device comprising:
a lift frame having first and second opposing sides, a top surface and a bottom surface;
an upper platform deck having first and second opposing sides, a top surface and a bottom surface, each of said lift frame and upper platform deck having an overall shape and construction suitable for receiving a commercial pallet;
a pair of opposing scissor lifts, each of said lifts including a first cross member and a second cross member, said first and second cross member of each of the opposing scissor lifts being pivotally joined at a central axis;
a cross brace orthogonally mounted between the opposing scissor lifts, said cross brace being secured to each cross member at the central axis;
wherein the first cross member of each of the opposing scissor lifts is pivotally mounted to the upper platform deck at an upper end, and slidingly engaged to the lift frame at a bottom end, and
the second cross member of each of the opposing scissor lifts is slidingly engaged to the upper platform deck at an upper end, and pivotally mounted to the lift frame at a bottom end;
an elongated lift bar that is orthogonally mounted to the first cross member of each of the opposing scissor lifts at the bottom end; and
a lifting device having an adjustable length arm that is disposed between the lift frame and the lift bar, said lifting device and arm functioning to impart a linear force onto the lift bar to raise and lower the upper platform deck.

2. The device of claim 1, wherein the lifting device and adjustable length arm comprise a hydraulic cylinder and piston rod, respectively.

3. The device of claim 2, further comprising:
a connector having an integrated vehicular hydraulic line adaptor, said adaptor functioning to mate with a vehicular hydraulic line and to supply hydraulic fluid to the cylinder.

4. The device of claim 3, wherein the upper platform deck rises from the lift frame when hydraulic fluid is supplied to the hydraulic cylinder, and the upper platform deck lowers to the lift frame when hydraulic fluid is not supplied to the hydraulic cylinder.

5. The device of claim 1, wherein the lifting device comprises an electrically operated hydraulic motor.

6. The device of claim 5, further comprising:
a hydraulic fluid reservoir that is connected to the electric motor.

7. The device of claim 1, wherein the lifting device comprises an electrically powered linear actuated motor.

8. The device of claim 1, further comprising:
a pair of opposing glide channels disposed along an inside portion of each of the upper platform deck and the lift frame along the first and second sides, respectively, said glide channels functioning to accommodate the sliding movement of the scissor lifts.

9. The device of claim 1, further comprising:
a pair of generally L-shaped frame rails that are secured to an outside portion of the lift frame along an entirety of the first and second sides, each of said frame rails including
a generally vertical section extending below the lift frame, and
a generally horizontal section extending outward from the lift frame, said horizontal section forming a lip for securing the device within an opening of a vehicle floor.

10. The device of claim 9, wherein the vertical section of the pair of frame rails are separated by a distance of approximately 24 inches.

11. The device of claim 9, further comprising:
a plurality of mounting brackets disposed along at least one of an inside portion and an outside portion of the vertical section of the pair of frame rails, said brackets functioning to secure the device to vehicular frames of varying sizes.

12. The device of claim 1, further comprising:
a pair of ramps that are hingedly secured to the first and second sides of the upper platform deck.

13. The device of claim 1, further comprising:
a plurality of attachment plates configured to secure the device onto a floor portion of the vehicle.

14. The device of claim 1, further comprising:
a steel plate secured across an entirety of the top surface of the upper platform deck.

15. A method for utilizing a lifting device with a vehicle, said method comprising:
providing a lifting device that includes
a lift frame, and an upper platform deck, each having an overall shape and construction suitable for receiving a commercial pallet,
a pair of opposing scissor lifts interposed between the lift frame and the upper platform deck, said lifts being connected along a bottom end thereof via a lift bar,
a lifting device having an adjustable length arm that is disposed between the lift frame and the lift bar, said lifting device and arm functioning to impart a linear force onto the lift bar to raise and lower the upper platform deck, and
a pair of frame rails secured to an outside portion of the lift frame, each of said frame rails including a generally vertical section extending below the lift frame, and a generally horizontal section extending outward from the lift frame;
providing an opening along a floor section of the vehicle at a location above a frame member of the vehicle;
lowering the lifting device into the opening;
positioning the horizontal section of the lift frame onto the vehicle floor; and
securing the vertical section of the lift frame onto the vehicle frame.

16. The method of claim 15, wherein the lifting device further includes a hydraulic cylinder, a piston rod, and a vehicular hydraulic line adaptor, and further comprising the steps of:
connecting the hydraulic line adapter to a vehicle hydraulic system; and
controlling an operation of the device via a vehicle hydraulic system controller.
